(19) United States
(12) Patent Application Publication
(10) Pub. No.: US 2002/0101081 A1
(43) Pub. Date: Aug. 1, 2002

(54) Electric motor driven rail vehicle with internal combustion engine

(76) Inventor: Andreas Jockel, Nurnberg (DE)

Correspondence Address: Henry M. Feiereisen, Suite 3220, 350 Fifth Avenue, New York, NY, 10118, US

(21) Appl. No.: 10/057,446

(22) Filed: Jan. 25, 2002

(30) Foreign Application Priority Data
Jan. 26, 2001 (DE) 101 03 538.1

(51) Int. Cl. H02P 9/04; H02K 7/20

(52) U.S. Cl. 290/8

(57) ABSTRACT

An electric motor driven rail vehicle with an internal combustion engine includes at least one generator/motor system with a permanent-magnet-excited synchronous machine or an asynchronous machine. The internal combustion engine and the permanent-magnet-excited synchronous machine or an asynchronous machine are mechanically coupled, preferably through a flange coupling. The rail vehicle can operate in dual mode, i.e., either with diesel power or with DC or AC electric power derived from a catenary. The diesel engine can function as a continuous engine brake by reversing the current flow in the current converter device.

### CROSS-REFERENCES TO RELATED APPLICATIONS

This application claims the priority of German Patent Application Serial No. 101 03 538.1, filed Jan. 26, 2001, the subject matter of which is incorporated herein by reference.

### BACKGROUND OF THE INVENTION

The present invention relates to an electric motor driven will vehicle with an internal combustion engines and a generator-motor system.

Traction vehicles employing internal combustion engines, in particular vehicles with diesel-electric traction, have diesel generators to provide power. Such diesel-electric generators are typically implemented as a DC-excited three-phase synchronous generators with brushless excitation, with the output voltage rectified with a diode bridge rectifier. These devices are difficult to manufacture and tend to have a high failure rate, in particular due to the relatively complex design of the rotor and the diodes of the exciter which rotate together on the shaft.

It would therefore be desirable and advantageous to provide an improved generator-motor-system for an electric motor driven rail vehicle with an internal combustion engine, which is less susceptible to malfunction and provides an increased overall system efficiency of the rail vehicle.

### SUMMARY OF THE INVENTION

According to one aspect of the invention, an electric motor driven rail vehicle with an internal combustion engine has a generator-motor-system with a permanent-magnet-excited synchronous machine or an asynchronous machine and a rectifier device adapted to supply electric power to at least one traction motor of the rail vehicle. The internal combustion engine and the permanent-magnet-excited synchronous machine or asynchronous machine are directly flange-mounted to one another.

This generator-motor-system represents a simple electric machine with a rectifier. Unlike with conventional machines, with this arrangement the electronic circuitry that produces the excitation is stationary.

Advantageously, the simple and robust design of the rotor of a permanent-magnet-excited synchronous machine or asynchronous machine reduces the occurrence of malfunctions in comparison to conventional systems. This increases the overall system efficiency, resulting in a reduced fuel consumption of the internal combustion engine. In particular, the internal combustion engine of the electric motor driven rail vehicle of this type can be a diesel engine.

Moreover, unlike conventional systems, the novel generator-motor-system has significantly less weight and a reduced overall axial length. The internal combustion engine also does not require a starter motor, since the permanent-magnet-excited synchronous machine or asynchronous machine itself can be used to start the internal combustion engine. As another advantage, the braking resistor can also be eliminated or at least be designed for a reduced thermal load, because during braking phase of the electric motor driven rail vehicle, unlike with conventional systems, the generator-motor-system can operate in a motive mode, with the braking energy being transferred to the internal combustion engine. Advantageously, the engine brake of the internal combustion engine can be dimensioned so that the continuous braking power of the rail vehicle becomes identical to the installed traction power.

The rectifier device supplies at least one traction motor. However, several traction motors of the traction vehicle can be supplied and connected in parallel.

In another embodiment of the invention, a section of the current rectifier device can be implemented as a pulse rectifier (active front end, AFE) which supplies the three-phase AC voltage of the permanent-magnet-excited synchronous machine or asynchronous machine to an indirect rectifier circuit. Active front end (AFE) refers to an active input current rectifier capable of returning the braking energy to the electrical machine. This enables two-quadrant operation, i.e., driving and braking by reversing the moment. An AFE device is described, for example, in U.S. Pat. No. 6,072,707 which is incorporated herein by reference.

In another advantageous embodiment of the invention, when operating the rail vehicles in dual-mode DC (either diesel operation or electric operation on a DC catenary), the pulse rectifier (AFE) can be rearranged for electric operation and employed as a second pulse current inverter, the traction power in electric operation can be doubled.

Likewise, when operating the rail vehicles in dual-mode AC rail vehicles (either in diesel operation or electric operation on an AC catenary), the pulse rectifier (AFE) can be rearranged for electric operation on an AC catenary and be used as a four-quadrant control element. In this way, a dual-mode-AC rail vehicle can be designed without requiring an additional current rectifier. Only an additional main transformer and a series tuned wave trap will have to be installed.

Advantageously, a current inverter which powers one or several traction motors, can be connected following the indirect rectifier circuit. With this arrangement, the three-phase traction motors can be powered from the indirect rectifier circuit via current inverters. Alternatively, DC motors can be powered directly from the intermediate circuit of the current rectifier device.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic block diagram of a generator system of the invention for dual-mode operation receiving power from a diesel engine;

FIGS. 2A, 2B are schematic block diagrams of the generator system of FIG. 1 operating in DC mode and AC mode, respectively;

FIG. 3 is a schematic block diagram of a generator system of the invention operating in braking mode; and

FIG. 4 is a schematic block diagram of a conventional generator system.

### DETAILED DESCRIPTION OF PREFERRED EMBODIMENTS

Throughout all the Figures, same or corresponding elements are generally indicated by same reference numerals.

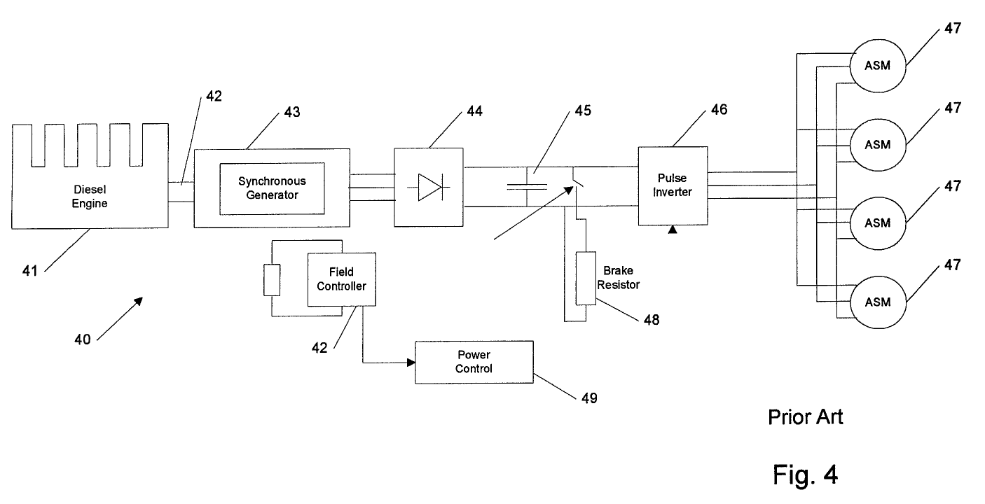

For background information and referring first to FIG. 4, a conventional diesel generator system includes a diesel engine 41 which is coupled to a brushless synchronous generator 43 having a field regulator 42 for adjusting the electric output power supplied by the generator 43. The rotor typically has a field winding with diodes, as described in the background section. The produced AC voltage is rectified by rectifier 44 and supplied via a DC intermediate circuit 45 to a pulse rectifier 46, converting the DC voltage into a three-phase AC voltage which powers the motor(s) 47. The traction power supplied to the vehicle is controlled by a power controller 49 by controlling the field regulator 42 and/or the pulse rectifier 46. In braking mode, the electric power produced by the motors 47 (which now operate as generators) is controllably dissipated by a braking resistor 48. The diesel engine 41 typically does not provide braking power.

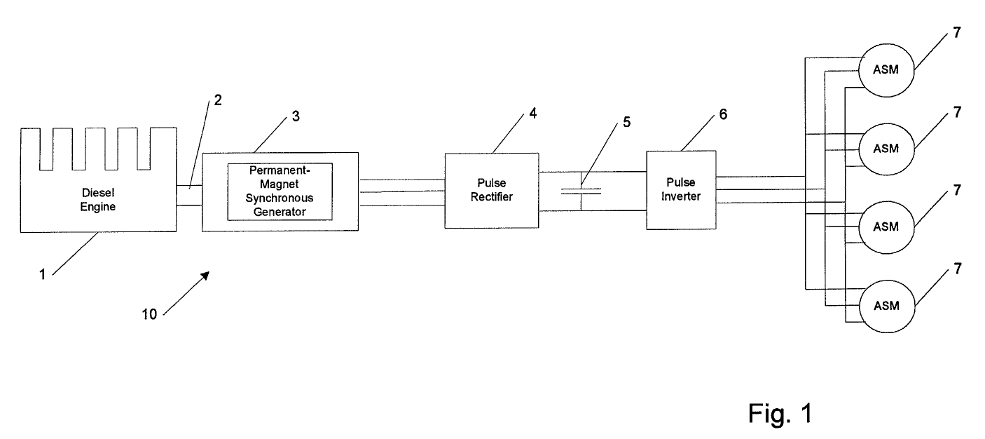

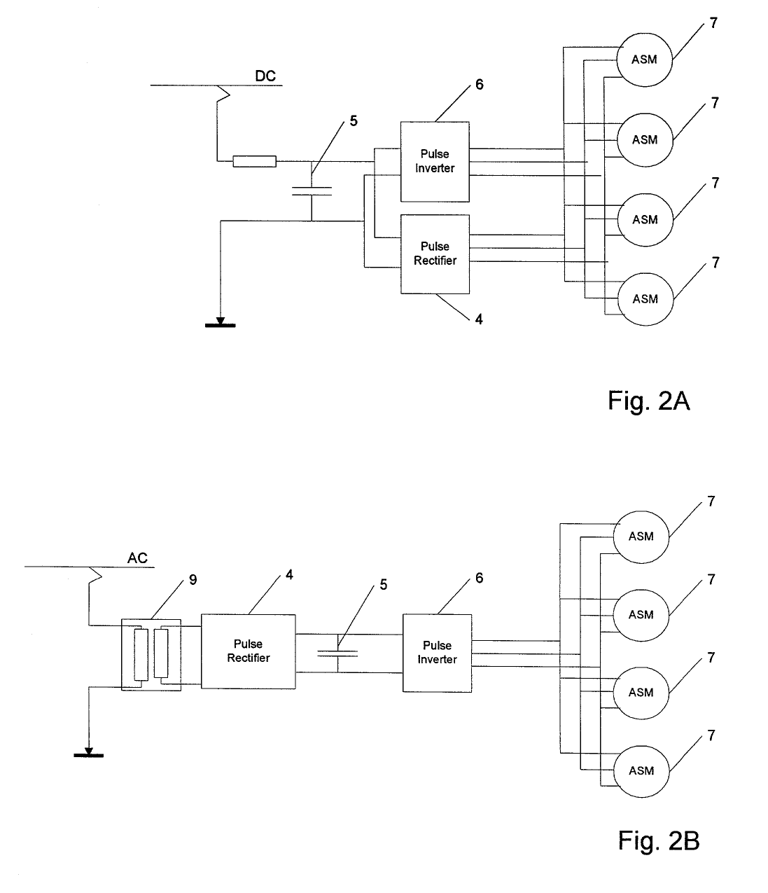

Referring now to FIG. 1, in a generator system according to the invention for dual-mode operation, a diesel engine 1 drives a generator 3, for example, a permanent-magnet-excited synchronous generator, which is coupled to the motor 1 by torque-transmitting means 2. Alternatively, an asynchronous generator can also be employed instead of the permanent-magnet-excited synchronous generator 3. The term “dual-mode” indicates that the traction vehicle can be powered either by the diesel engine-generator combination or directly from a DC or AC catenary, as described below with reference to FIGS. 2A and 2B.

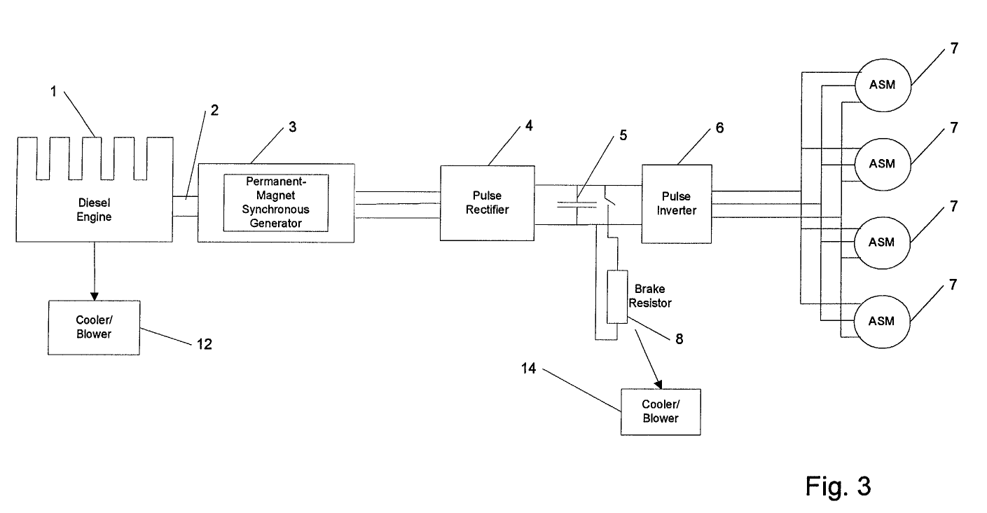

The diesel engine 1 and the generator 3 can be directly flange-coupled to one another. The shaft 2 transmits the traction power from the diesel engine 1 to the generator 3. In the braking mode, which will be described below with reference to FIG. 3, the generator 3 operates as a motor and transfers the braking power of the electric-driven rail vehicle to the diesel engine 1 via the torque-transmitting means 2. During normal operation (with the diesel engine 1 powering the electric-driven rail vehicle), the exemplary permanent-magnet-excited synchronous generator 3 supplies a three-phase AC voltage to a pulse rectifier 4 which powers a DC intermediate circuit 5. In one embodiment employing DC traction motors (not shown), the DC intermediate circuit 5 can provide electric power directly to a DC motor. In the example illustrated in FIG. 1, the DC voltage of the intermediate circuit 5 is converted by a current inverter 6 into a three-phase AC voltage, which in turn supplies power to one or several three-phase AC traction motors 7.

FIGS. 2A and 2B show the operation of the generator system of FIG. 1 in DC mode (FIG. 2A) and AC mode (FIG. 2B). When deriving electric power from the catenary, the diesel engine 1 and the permanent-magnet-excited synchronous generator 3 are disconnected from the remainder of the electric traction circuitry 4, 5, 6 and 7. When operating in DC or AC mode, the traction power is typically significantly greater, for example by a factor or two, than in diesel-electric operation. However, it would not be technically and economically justifiable to size the drive motors and the electric equipment, such as the pulse rectifier 4 and the inverter 6, for twice the diesel power.

According to the invention, in DC mode catenary operation illustrated in FIG. 2A, the pulse rectifier 4, which is otherwise used in diesel operation only as rectifier for the generator 3, is used as an additional pulse inverter for supplying electric power to the traction motors 7, thereby doubling the supplied electric power to the traction motors 7.

In AC mode catenary operation illustrated in FIG. 2B, the pulse rectifier 4, which is otherwise used in diesel operation as a rectifier for the generator 3, is connected as a four-quadrant regulator 4 (supply current rectifier) which feeds the intermediate circuit 5 of the drive motors 7. An additional transformer 9 may be connected between the catenary and the four-quadrant regulator 4 for adapting to the different catenary voltages.

Referring now to FIG. 3, in braking mode the drive motors 7 operate as generators. The electric circuitry operates in the opposite direction of FIG. 1, in that the electric braking power produced by the AC motors (generators) 7 is rectified in pulse rectifier 6 and supplied via the intermediate circuit 5 to pulse inverter 4, which generates AC power to drive the generator 3 which now operates as a motor. The motor 3 drives the diesel engine 1 which is flange-coupled 2 to the generator 3, with the diesel engine 1 functioning as engine brake, dissipating most, if not all of the braking power produced by the AC motors 7. Any excess braking power that is not dissipated by the diesel engine 1 can be dissipated by an additional brake resistor 8, similar to the brake resistor 48 of the conventional system 40 depicted in FIG. 4. However, in most cases, no additional brake resistors are required either for the driving or for the braking operation, since the diesel engine 1 can be sized to receive the sustained-action braking power. Conventional cooling elements 12, 14 can be provided to cool the diesel engine 1 and the brake resistor 8.

With the arrangement of the invention, the drive system of the electric-motor-driven rail vehicle can be simplified, and its overall dimensions as well as its weight can also be reduced. The system has a higher efficiency than conventional diesel-electric drive systems and requires less maintenance.

While the invention has been illustrated and described as embodied in an electric motor driven rail vehicle with internal combustion engine, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An electric motor driven rail vehicle, comprising:
an internal combustion engine;
at least one generator/motor system with a permanent-magnet-excited synchronous machine or an asynchronous machine;
at least one traction motor; and
a current converter device which supplies electric power to the least one traction motor,
wherein the internal combustion engine and the permanent-magnet-excited synchronous machine and/or asynchronous machine are mechanically coupled to one another.

2. The electric motor driven rail vehicle of claim 1, wherein the current converter device comprises at least one pulse rectifier.

3. The electric motor driven rail vehicle of claim 2, wherein the current converter device further comprises an intermediate circuit and at least one inverter which supplies the electric power to the at least one traction motor.

4. The electric motor driven rail vehicle of claim 1, wherein the permanent-magnet-excited synchronous machine includes at least one connection for three-phase AC voltage.

5. The electric motor driven rail vehicle of claim 1, wherein the internal combustion engine and synchronous machine are directly flange-coupled to one another.

6. Electric motor driven rail vehicle of claim 1, wherein the internal combustion engine is implemented as a diesel engine.

7. The electric motor driven rail vehicle of claim 1, wherein in a braking mode of the rail vehicle, the current converter device is connected to receive continuous electric braking power from the at least one traction motor and supply the received braking power to the at least one generator/motor system, with the internal combustion engine operating as an engine brake.

8. The electric motor driven rail vehicle of claim 3, wherein the pulse rectifier when the rail vehicle receives electric power from a DC catenary, is connected in parallel with the inverter so as to double the electric power supplied to the at least one traction motor.

9. The electric motor driven rail vehicle of claim 3, wherein the pulse rectifier when the rail vehicle receives electric power from an AC catenary, operates as a four-quadrant regulator.

10. The electric motor driven rail vehicle of claim 9, further comprising a transformer connected between the AC catenary and the pulse rectifier.
